(19) United States
(12) Patent Application Publication
(10) Pub. No.: US 2018/0312045 A1
(43) Pub. Date: Nov. 1, 2018

(54) FLUSH GLAZED DEVICE FOR VEHICLE DOOR WITH MOVABLE PANEL, CORRESPONDING DOOR AND MOTOR VEHICLE

(71) Applicant: ADVANCED COMFORT SYSTEMS FRANCE SAS - ACS FRANCE, Bressuire (FR)

(72) Inventor: Philippe CHARGE, Bressuire (FR)

(21) Appl. No.: 15/740,419

(22) PCT Filed: Dec. 9, 2016
(86) PCT No.: PCT/FR2016/053320

§ 371 Date: Dec. 28, 2017

(51) Int. Cl. B60J 5/04; B60J 1/17; B60J 10/79

(52) U.S. Cl. CPC B60J 5/0402; B60J 10/79; B60J 5/0408; B60J 1/17

(57) ABSTRACT

The invention relates to a glazed device (12) intended to be assembled in a bodywork chamber in order to form a motor-vehicle door, comprising at least one movable glazed panel (121) carrying, on its face oriented towards the inside of the vehicle, at least two guide shoes (26, 27) each mounted slidably with respect to a guide rail (22_{A}, 22_{B}).

According to the invention, the glazed device (12) comprises a stop (57) for blocking the glazed panel (121) in the longitudinal direction (X) at least of said vehicle, said blocking stop (57) being secured to a first guide rail (22_{A}, 22_{B}).

### FIELD OF THE INVENTION

The field of the invention is that of motor vehicles.

More precisely, the invention relates to vehicle doors, and in particular the equipping of openings provided in such doors.

Yet more precisely, the invention relates to vehicle doors equipped with at least one glazed panel able to move substantially vertically, in particular for passing from a closed position to an open position, in which it completely or partially enters a lower bodywork chamber (the movable panel of course being able to adopt generally a plurality of intermediate positions).

Such a vehicle door may in particular be a side door, but the invention may also apply, for example, to swinging and/or sliding doors of a vehicle, including the rear doors, tailgates, etc.

The invention relates in particular to a glazed device, intended to be assembled in a bodywork chamber in order to form a vehicle door, on which the glazed surface is flush, that is to say according to which no frame appears seen from the outside.

### PRIOR ART

Examples of such glazed devices are described in particular in the patent documents EP 1 422 091 and EP 1 612 072.

According to this approach, a door structure and a glazed assembly are manufactured separately and assembled by superimposition in order to form a vehicle door.

The glazed assembly 12 comprises a frame, intended to be oriented towards the inside of the vehicle, carrying one of more (conventionally two) rails 22_{A}, 22_{B}, cooperating with shoes secured to the movable glazed panel 121, and fixed to the face thereof oriented towards the inside of the vehicle.

This technique is advantageous since it makes it possible to conceive of original designs, because of the elimination of the conventional door frame, while keeping effective guidance and holding of the movable panel.

An improved version of this approach is proposed in the patent document FR 3 021 254, in the name of the applicant of the present patent application, which describes a simple and effective adjustment of the shoes, making it possible to obtain precise predetermined guidance of the movable panel, provided by the rails and shoes, despite the relatively great tolerances that may exist from one vehicle to another.

However, other problems of mounting, assembly and guidance may arise, in particular because of the position of the movable glazed panel 121 with respect to the trim element 56 placed on the frame of the glazed assembly 12, as illustrated in FIG. 1, and extending in the plane of the movable glazed panel 121 when it is in the closed position.

The position of the trim 56 and/or of the glazed panel 121 must take account of the manufacturing and operating tolerances and clearances, but these are not always compatible with an additional clearance in the longitudinal direction of the vehicle (direction X) for the movement of the glazed panel 121.

It may be necessary, for example, to compensate for defects in parallelism between the rails guiding the glazed panel 121 and the rail R of the window winder when the glazed panel 121 is raised, lowered, when the rails guiding the glazed panel 121 and the rail R of the window winder are not assembled on the same station.

There therefore exists a need to control the position along X of the glazed panel 121, and to guarantee that guidance thereof takes place without clearance so as to preserve a minimal clearance J between the top and bottom parts (along the axis Z corresponding to the height of the vehicle) of the trim 56 and the edge of the glazed panel 121.

### Objectives of the Invention

The objective of the invention is in particular to overcome this drawback.

More precisely, one objective of the invention is to provide a glazed device for producing a vehicle door, which allows simple and effective guidance of the glazed panel, without clearance or with very small clearance in the direction X.

The objective of the invention is to provide a vehicle door having an appearance that is flush in itself and with the bodywork, and which has good structural and sealing quality.

Another objective of the invention is to provide such a glazed device that is simple to implement and to assemble, for example on an assembly line.

Yet another objective of the invention is to provide such a glazed device which can easily be maintained or replaced, for example following an accident.

### Disclosure of the Invention

This objective, as well as others that will emerge hereinafter, are achieved by means of a glazed device intended to be assembled on a bodywork chamber in order to form a motor-vehicle door, comprising at least one movable glazed panel carrying, on its face oriented towards the inside of the vehicle, at least two guide shoes each mounted slidably with respect to a guide rail.

According to the invention, the glazed device comprises a stop for blocking the glazed panel in the longitudinal direction at least of said vehicle, said blocking stop being secured to a first guide rail.

In a particular embodiment, one of said rails carries the stop blocking the glazed panel in the longitudinal direction at least of said vehicle.

In a variant, the blocking stop is carried by a trim disposed in the vicinity of a lateral edge of the glazed panel, the trim being carried by one of said rails.

Thus this stop blocks any movement of the glazed panel along X, without opposing the sliding thereof. Naturally, the blocking exists only in the direction X, and allows guidance in the direction Z (the height of the vehicle) and where applicable in the transverse direction Y (corresponding to the width of the vehicle). It is therefore a “stop for blocking along X and guidance along Z and where applicable Y”, referred to here as “blocking stop” for simplification.

Thus it is possible to have a precise movement of the glazed panel, and therefore to keep minimal clearance between the top and bottom parts (along the axis Z) of a trim disposed in the vicinity of a lateral edge of the glazed panel, for each device and each door, despite the tolerances necessary for the manufacture and assembly of the vehicles.

It should be noted here that the glazed device of the invention uses two rails, for example one at the front and the other at the rear, for a device intended to be mounted on a side door or wall of a vehicle.

Only one of these rails is equipped with such a stop for blocking along X according to the invention, for example at the rear for a front door, or at the front for a rear door.

This stop for blocking along X is situated in the vicinity of the bottom part of the guide rail and secured to the latter so that the movable glazed panel is forced against this stop when it moves.

It should be noted that the stop for blocking along X serves to guarantee the clearance between the glazed panel and the trim only when the glazed panel is closed. When the glazed panel is open or partially open, the contact between the glazed panel and the stop for blocking along X is not obligatory. In some cases, the glazed panel moves away slightly from the stop for blocking along X during descent and approaches it on being raised, whereas in other cases the glazed panel is always in contact with the stop for blocking along X. This phenomenon relates to the form of the windows and their pathways.

According to a particular aspect of the invention, said blocking stop has at least one surface for blocking a lateral edge of the glazed panel.

According to a particular aspect of the invention, said blocking stop has a first blocking surface extending in the transverse direction of said vehicle.

According to a particular embodiment, said blocking stop has a second blocking surface extending in the longitudinal direction of said vehicle so as to allow a movement of the glazed panel without clearance or with small clearance in the transverse direction of the vehicle.

The blocking stop allows a movement of the glazed panel without clearance or with very small clearance in the direction Y.

This prevents the movable glazed panel being offset towards the outside and where applicable the inside of the vehicle.

This Y blocking at the bottom part of the glazed panel makes it possible to compensate for the action of the seals, which have a tendency to push the glazed panel outwards.

Without this stop for blocking along Y, the thrust of the seals would make the glazed panel emerge along Y with respect to the trim.

According to a particular aspect of the invention, said blocking stop has a third blocking surface extending in the longitudinal direction of said vehicle and substantially parallel to the second blocking surface, the blocking surfaces delimiting a slot in which the lateral edge of the base panel is housed.

According to a particular aspect of the invention, a second guide rail carries a stop for blocking the glazed panel in the transverse direction of said vehicle.

According to a particular aspect of the invention, the first guide rail carries a trim element the edge of which extends substantially parallel to said lateral edge of the glazed panel.

According to a particular aspect of the invention, at least one of said guide rails has an essentially circular cross section, said corresponding shoe or shoes also having an essentially circular cross section.

This cylindrical form can in particular facilitate assembly and tolerate clearances.

Other cross sections of the rails and shoes respectively, for example rectangular or square, are also possible.

According to a particular aspect of the invention, at least one of said blocking surfaces is covered with a slip covering. It may be a covering layer of a material with a low coefficient of friction, for example polyoxymethylene.

The invention also relates to motor-vehicle doors, comprising a glazed device as described above, as well as the motor vehicles comprising at least one such glazed device.

### DISCLOSURE OF THE FIGURES

Other features and advantages of the invention will emerge more clearly from a reading of the following description of the embodiments of the invention, given by way of simple illustrative and non-limitative examples and the accompanying drawings, among which:

FIG. 1 is a general view of a glazed device according to the invention intended to be assembled in a door chamber in order to form a front motor-vehicle door;

FIG. 2 is a detailed view of a glazed device according to the invention having two shoes;

FIG. 3 is a detail view of the stop for the blocking along X of the position the movable glazed panel of the glazed device according to the invention;

FIG. 4 is a view in cross section AA of a portion of FIG. 3, and presents a first embodiment of the stop for blocking in two directions;

FIG. 5 is a view in cross section BB of a portion of FIG. 2;

FIG. 6 presents a second embodiment of the stop for blocking in three directions.

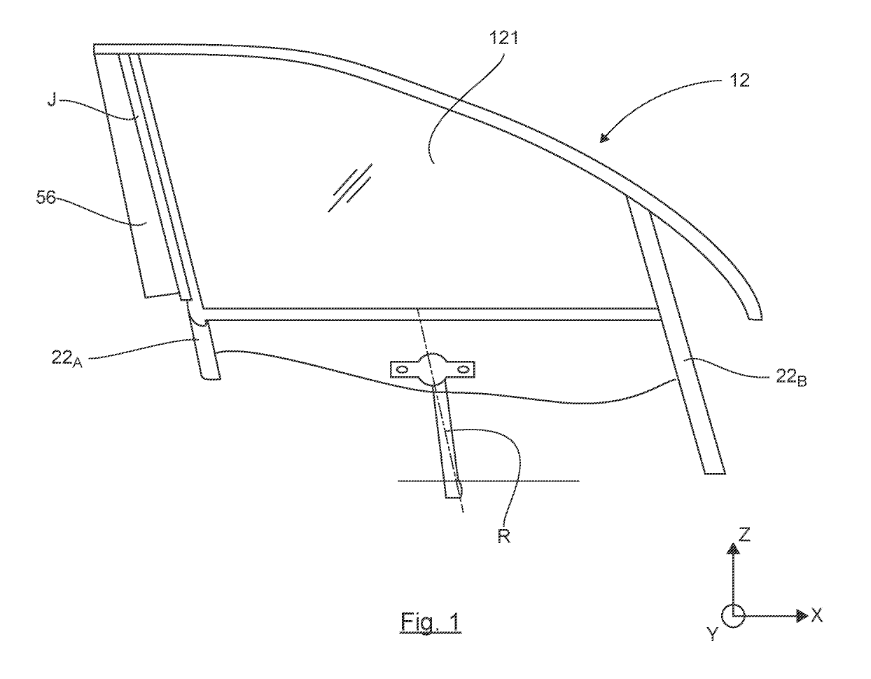

### DETAILED DESCRIPTION OF EMBODIMENTS

The invention therefore relates to a motor-vehicle door and in particular the glazed part thereof, which is flush, that is to say no frame or frame element projects towards the outside of the vehicle with respect to the plane of this glazed part.

The embodiment described below relates to a front side door.

However, naturally, the same approach can be implemented on other doors of a vehicle.

This door comprises conventionally a door chamber, forming the structure of this door. The chamber comprises a first top frame, which defines an opening, and is connected to a bottom part that comprises in particular elements for receiving and holding the glazed part.

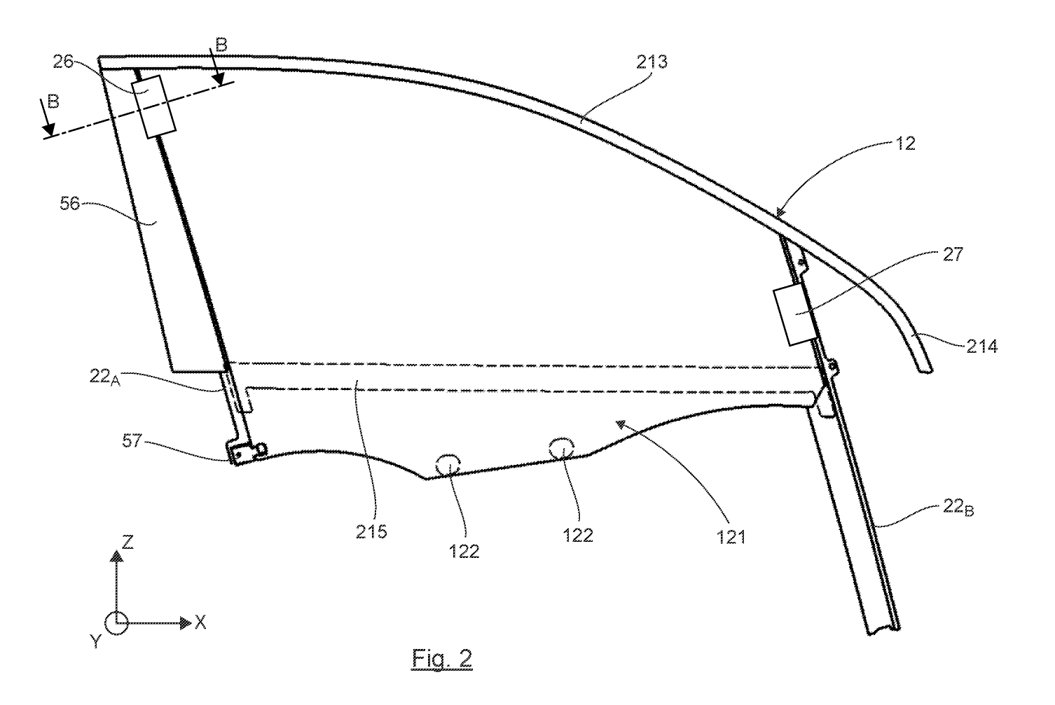

This glazed part, or glazed device, 12 is produced independently, as illustrated in FIG. 2, and next assembled with the chamber, in order to form the door.

The glazed part 12 is configured so as to offer a flush appearance.

This comprises a movable glazed panel 121, able to be moved from a closed position to an open position. In FIG. 2, the movable part is in the closed position.

This glazed part 12 comprises a second frame that has substantially the same form as the first frame of the door structure.

This second frame has a top cross member 213 following the curve of the top part of the glazed part and connecting two uprights each formed by a rail 22_{A}, 22_{B} for sliding guidance of the movable glazed panel 121, a central cross member 215, and a front element 214 intended to be associated with a fixed glazed part (not illustrated).

It should be noted that the rails 112_{A}, 112_{B} constitute structural elements of the glazed part 12.

The movable glazed panel 121 is moved by drive means (not illustrated), for example a rack mechanism, actuated itself by an electric motor (not illustrated). These drive means are situated in the bottom part of the door chamber. Other drive means, including manual drive means, may of course be used.

Guide shoes are fixed to the face of the movement panel 121 oriented towards the inside of the vehicle, in order to cooperate with the rails 22_{A}, 22_{B}. Although in practice they are generally not visible from outside (the corresponding zone being screen printed), the positions thereof have been shown in FIG. 2.

In this embodiment, a single shoe 26 for guidance along XY is provided for cooperating with the rail 22_{A} oriented towards the rear, and a single shoe 27 for guidance along Y is provided for cooperating with the rail 22_{B} oriented towards the front.

The rear shoe 27 has, according to this embodiment, an essentially cylindrical cross section. The rail 22_{A} has an essentially cylindrical complementary shape. Thus the respective cross sections of the shoe and of the rail allow a rotation of the movable panel about the axis Z. This cylindrical shape can in particular facilitate assembly and tolerate clearances.

According to a particular embodiment, said shoe is overmoulded on a metal insert.

The overmoulding can in particular be carried out in polyoxymethylene (POM).

The glazed part 12 is assembled independently of the door chamber, and then mounted on the latter by fixing the top cross member 213 and the rails 22_{A}, 22_{B} on the chamber.

A door that can be mounted directly on the vehicle is then available.

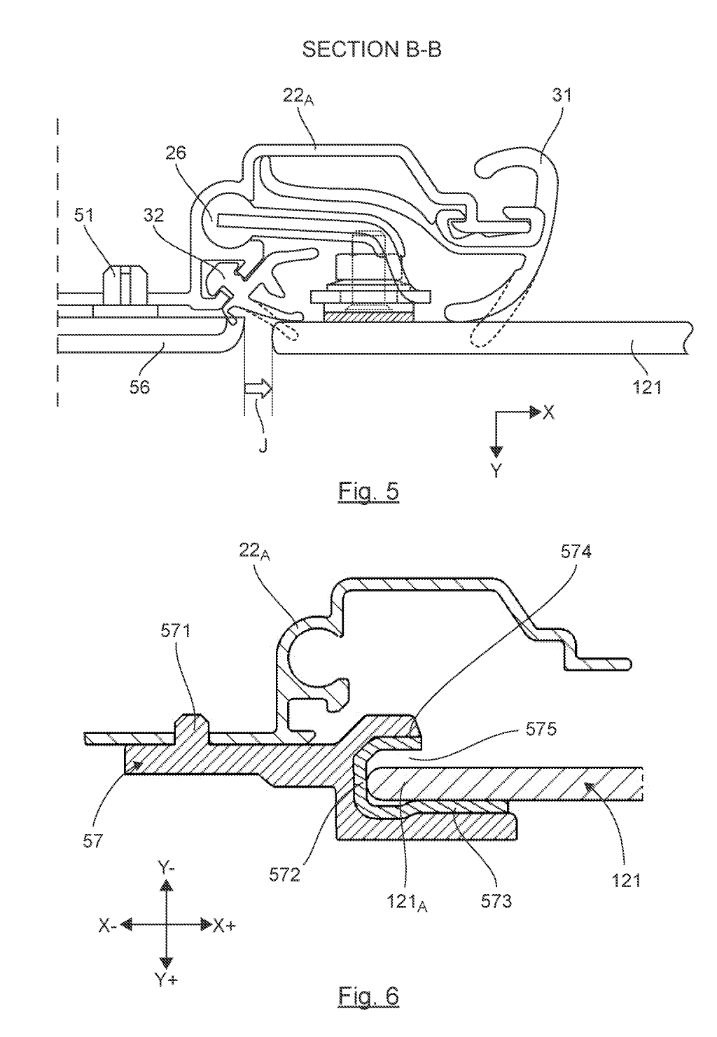

The second frame may carry a plurality of seals 31, (seen in cross section in FIG. 5). It also receives a trim element, or finishing element, 56 extending in the plane of the movable glazed panel 121 when the latter is in the closed position.

More precisely, the rear guide rail 22_{A} receives a trim 56, which is positioned so as to be aligned with the edge 121_{A} of the movable glazed panel 121 while minimising the clearance J with the latter, for aesthetic reasons.

The trim 56 has a plurality of centring elements 561 projecting from its internal face cooperating with apertures provided in the rail 22_{A}. It further has locking elements (not visible) in order to hold the trim 56 in position on the rail 22_{A} during use of the vehicle, and to prevent its becoming dismantled under the effect of shocks or vibrations. The trim 56 can also be easily dismantled.

The trim 56 is mounted directly on the rear guide rail 22_{A}, unlike the trims of glazed devices of the prior art, which are fixed to the vehicle door structure. It can be fixed to the rail 22_{A} before or after assembly of the glazed part 12 on the vehicle door chamber. The trim 56 can easily be assembled on the glazed part 12 directly at the suppliers.

In the case where the window guide rails 22_{A}, 22_{B} and the window-winder rail (not illustrated but secured to the fixing points 122 situated at the bottom part of the glazed panel 121) are not assembled on the same station, and it is necessary to compensate for any defects in assembly of the window winder by providing a window/window-winder connection allowing a relative movement along at least the axis X.

However, this degree of freedom necessary for the correct functioning of the system does not make it possible to provide a clearance along X between the glazed panel 121 and the trim 56 at the bottom part (at the top part, clearance is guaranteed by the guide shoe 26 along XY).

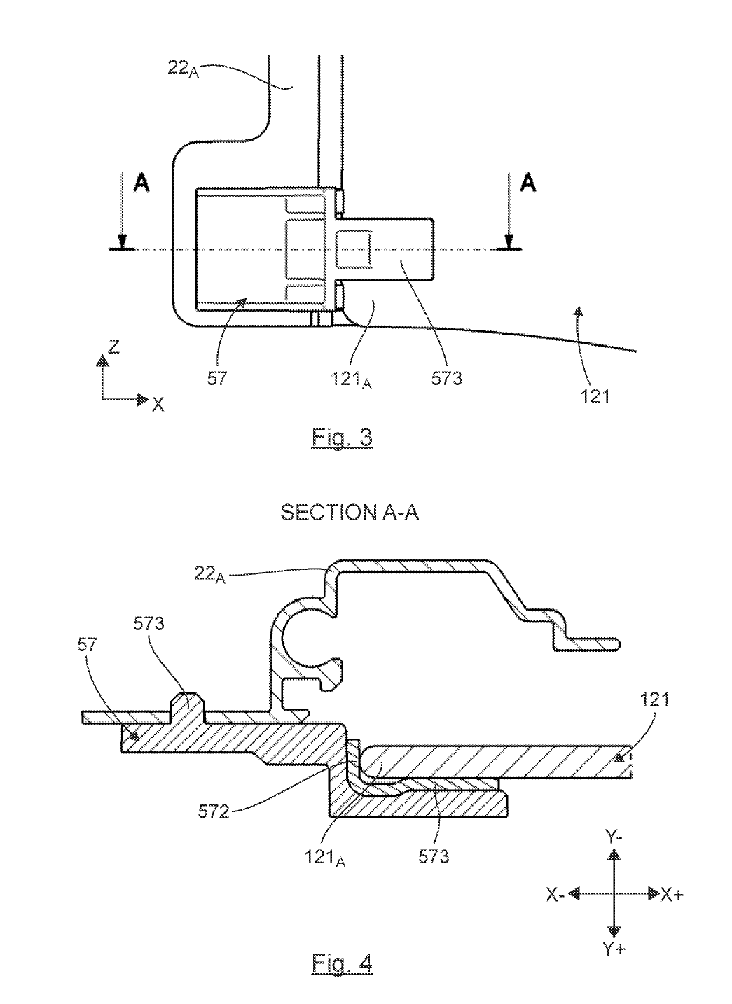

As illustrated in FIG. 3 (seen from the outside), the invention provides for the rear rail 22_{A} to carry a stop 57 for blocking the glazed panel 121 in the longitudinal direction X of the vehicle (and more precisely in the direction X−).

The blocking stop 57 is mounted on the rail 22_{A} in the vicinity of the bottom end of the latter. This blocking stop 57 blocks any movement along X of the glazed panel 121, without opposing the sliding of the latter along Z. In other words, this stop 57 for blocking along X situated at the bottom part of the rail 22_{A} blocks the movement of the glazed panel 121 along X with respect to the window-guide rail 22_{A}.

As illustrated by FIG. 4, which is a view in cross section AA level with the blocking stop 57, the latter has a first portion carrying a fixing element 571 intended to be snapped into an aperture in the rail 22_{A}. The first portion is extended by a second portion, which covers the rear lateral edge 121_{A} of the glazed panel 121, from the outside.

In the example illustrated, this second portion comprises a first lug, disposed on the outside of the glazed panel, and the internal surface of which that is turned towards the glazed panel 121 is in the form of an angle bracket.

The first lug has a first blocking surface 572 extending in the transverse direction Y of the vehicle and against which the edge of the glazed panel 121 comes into abutment. This first blocking surface 572 blocks any movement of the glazed panel 121 along X, which makes it possible to preserve a minimal clearance between the top and bottom parts (along the axis Z) of the trim 56 and the rear lateral edge 22_{A} of the glazed panel 121.

The first lug also has a second blocking surface 573 extending in the longitudinal direction X of the vehicle and against which the external surface of the glazed panel 121 comes into abutment, so as to prevent any movement of the glazed panel 121 towards the outside in the transverse direction Y of the vehicle. This blocking along Y at the bottom part of the glazed panel 121 compensates for the action of the seals, which have a tendency to push the glazed panel 121 outwards.

The blocking stop 57 thus provides blocking in two directions X− and Y+.

FIG. 6 presents a second embodiment of the blocking stop 57. The latter has two lugs defining a U-shaped slot 575 in which the rear lateral edge 121_{A} of the glazed panel 121 is housed, the lugs being disposed on the inside and outside respectively of the glazed panel 121. This slot 575 is delimited by first and second blocking surfaces 572, 573 and a third blocking surface 574.

The third blocking surface 574 extends in the longitudinal direction X of the vehicle, parallel to the second blocking surface 573. The distance between the second and third blocking surfaces 573, 574 is slightly greater than the thickness of the glazed panel 121 so as to allow a movement of the glazed panel 121 with small clearance in the transverse direction Y of the vehicle. This moreover prevents the movable glazed panel 121 being able to be offset towards the inside by an ill-intentioned person, when it is in the closed position.

The blocking stop 57 thus provides blocking in three directions X−, Y+ and Y−.

At least one of the blocking surfaces 572 to 574 is covered with a layer of additional material having a low coefficient of friction and high resistance to wear, such as polyoxymethylene.

In variants, it may be a layer of felt or a polyurethane strip.

In another variant, the stop 57 is a single-material piece.

The glazed assembly may also comprise one or more fixed glazed panels, or quarter lights.

In a particular embodiment, the movable glazed panel carries, on its face oriented towards the inside of the vehicle, two guide shoes each mounted so as to be able to slide with respect to a guide rail.

In another particular embodiment, the movable glazed panel carries a single guide shoe cooperating with one of the two guide rails in which the movable glazed panel slides.

Many additions or variants to the embodiment described above can of course be envisaged.

The rails may be configured so as to guide the movable glazed panel in a turning and sliding movement, so as to slightly move the movable glazed panel, during its movement, away from a frame or an upright against which it is in abutment, in a closed position.

In this case, at least one of the guide rails carries a ramp, providing the turning.

Other forms of stops may of course be used without departing from the scope of the invention. In all cases, they allow blocking in at least one direction, along X and where applicable along Y.

Moreover, the blocking stop 57 may be carried by the trim 56, itself being mounted on the rail 22_{A}.

1. Glazed device (12) intended to be assembled in a bodywork chamber in order to form a motor vehicle door, comprising at least one movable glazed panel (121) carrying, on its face oriented towards the inside of the vehicle, at least two guide shoes (26, 27) each mounted so as to be able to slide with respect to a corresponding guide rail (22_{A}, 22_{B}),
characterised in that the glazed device (12) comprises a stop (57) for blocking the glazed panel (121) in the longitudinal direction (X) at least of said vehicle, said blocking stop (57) being mounted on a first of said guide rails (22_{A}, 22_{B}).

2. Glazed device (12) according to claim 1, characterised in that said blocking stop (57) has at least one surface (572, 573, 574) blocking a lateral edge (121_{A}) of the glazed panel (121).

3. Glazed device (12) according to claim 2, characterised in that said blocking stop (57) has a first blocking surface (572) extending in the transverse direction (Y) of said vehicle.

4. Glazed device (12) according to claim 3, characterised in that said blocking stop (57) has a second blocking surface (573) extending in the longitudinal direction (X) of said vehicle so as to allow a movement of the glazed panel (121) without clearance or with small clearance in the transverse direction (Y) of said vehicle, toward the outside.

5. Glazed device (12) according to claim 4, characterised in that said blocking stop (57) has a third blocking surface (574) extending in the longitudinal direction (X) of said vehicle and substantially parallel to the second blocking surface (573), the blocking surfaces (572, 573, 574) delimiting a slot (575) in which the lateral edge (121_{A}) of the glazed panel (121) is housed.

6. Glazed device (12) according to claim 1, characterised in that a second guide rail (22_{A}, 22_{B}) carries a stop (57) for blocking the glazed panel (121) in the transverse direction (Y) of said vehicle.

7. Glazed device (12) according to claim 2, characterised in that the first guide rail (22_{A}, 22_{B}) carries a trim element (56) one edge of which extends substantially parallel to said lateral edge (121_{A}) of the glazed panel (121).

8. Glazed device (12) according to claim 1, characterised in that at least one of said guide rails (22_{A}, 22_{B}) has an essentially circular cross section, said corresponding shoe or shoes (26, 27) also having an essentially circular cross section.

9. Glazed device (12) according to claim 5, characterised in that at least one of said blocking surfaces (572, 573, 574) is covered with a slip covering.

10. Motor-vehicle door, characterised in that it comprises a glazed device (12) according to claim 1.

11. Motor vehicle, characterised in that it comprises at least one glazed device (12) according to claim 1.

12. Glazed device (12) according to claim 1, characterised in that said blocking stop (57) is mounted in the vicinity of the bottom end of said first guide rail (22_{A}, 22_{B}).

13. Glazed device (12) according to claim 12, characterised in that said blocking stop (57) comprises a fixing element (571) intended to be snapped into an aperture in said first guide rail (22_{A}, 22_{B}).

14. Glazed device (12) according to claim 9, characterised in that said blocking stop (57) is carried by said trim element (56).
